(19) United States
(12) Patent Application Publication
(10) Pub. No.: US 2007/0225952 A1
(43) Pub. Date: Sep. 27, 2007

(54) Method for Managing Graphics Lines

(76) Inventors: David Arneau, Pessac (FR); Eric Filliatre, Merignac (FR)

Correspondence Address: LOWE HAUPTMAN & BERNER, LLP, 1700 DIAGONAL ROAD, SUITE 300, ALEXANDRIA, VA, 22314, US

(21) Appl. No.: 11/587,055

(22) PCT Filed: Apr. 19, 2005
(86) PCT No.: PCT/EP05/51725

§ 371 Date: Oct. 20, 2006

(30) Foreign Application Priority Data
Apr. 20, 2004 (FR) 04/04146

(51) Int. Cl. G06F 7/60

(52) U.S. Cl. 703/2

(57) ABSTRACT

The field of the invention is that of graphics libraries supplying graphics functions used in the tracing of symbolic images. For certain applications, the screen comprises restricted areas, referred to as ‘clipboxes’, inside which no graphics objects must be traced. The method according to the invention allows elementary straight lines to be generated on a matrix display comprising restricted areas without filling the frame-buffer with segments of the straight line belonging to said restricted areas. The method comprises a first step for calculating the segments of the line situated strictly within the allowed area and a second step for tracing said segments in the allowed area.

The field of the invention is that of graphics libraries supplying graphics functions used in the tracing of symbolic images. One of the fields where the invention is particularly applicable is the generation of symbolic images for aircraft flight control. These images are notably used in navigation, flight control and the management of critical systems, such as engine monitoring.

Graphical images are generated on matrix display screens, such as for example liquid crystal displays. The generation of the graphics image is effected in the following manner: a buffer memory, referred to as ‘frame-buffer’, is filled with the various graphics symbols required by the image, these graphics symbols being assigned an order of priority; when all the graphics symbols have been created in the frame-buffer, its contents are then sent to the display. These graphics images are generated in real time.

In certain applications, the screen comprises restricted areas, called ‘clipboxes’, inside which no graphics object must be traced. This function is useful, for example, for displaying one or more video images that it is undesirable to clutter with graphics symbols.

In order to achieve this function, the solution usually adopted consists in assigning the highest priority order to the restricted areas in such a manner that the areas with graphics symbols of lower priority falling within the restricted areas are erased from the frame-buffer. In this scenario, graphics symbols may be created needlessly within the frame-buffer only to then be replaced with the desired content of the clipbox. Thus, unnecessary calculations are performed, and since the images are generated in real time and contain a very large number of pixels, the calculation and addressing times need to be optimized.

The object of the invention is to avoid filling the frame-buffer several times successively in the restricted areas by eliminating by calculation the graphics symbols falling in the restricted areas.

Any curve or any complex line may be decomposed into a certain number of elementary straight lines. The invention is applied to these elementary straight lines.

More precisely, the subject of the invention is a method for graphical generation of at least one straight line on a matrix display comprising at least one restricted area and one allowed area complementary to the restricted area, characterized in that said method comprises a first step for calculating the segments of the line situated strictly within the allowed area and a second step for tracing said segments in the allowed area.

Advantageously, when the display comprises two separate restricted areas, the method comprises the following sub-steps:
Calculation of the points of intersection between the line and the first restricted area;
Calculation of the first segments of the line situated outside of the first restricted area;
Calculation of the points of intersection between each of the first segments and the second restricted area when there exists at least one first segment outside of the first restricted area;
Calculation of the second segments of the line situated outside of the first restricted area and outside of the second restricted area;
Tracing of said second segments in the allowed area, when there exists at least one second segment outside of the first restricted area and outside of the second restricted area.

Advantageously, the ends of each segment are either an end of the line, or a point of intersection of the line with one of the restricted areas.

Advantageously, the restricted areas or the allowed areas are rectangular areas and the algorithm allowing the points of intersection to be calculated is of the Cohen-Sutherland or Cyrus-Beck type.

The invention will be better understood and other advantages will become apparent upon reading the description that follows, presented as a non-limiting example and with regard to the appended figures, among which:

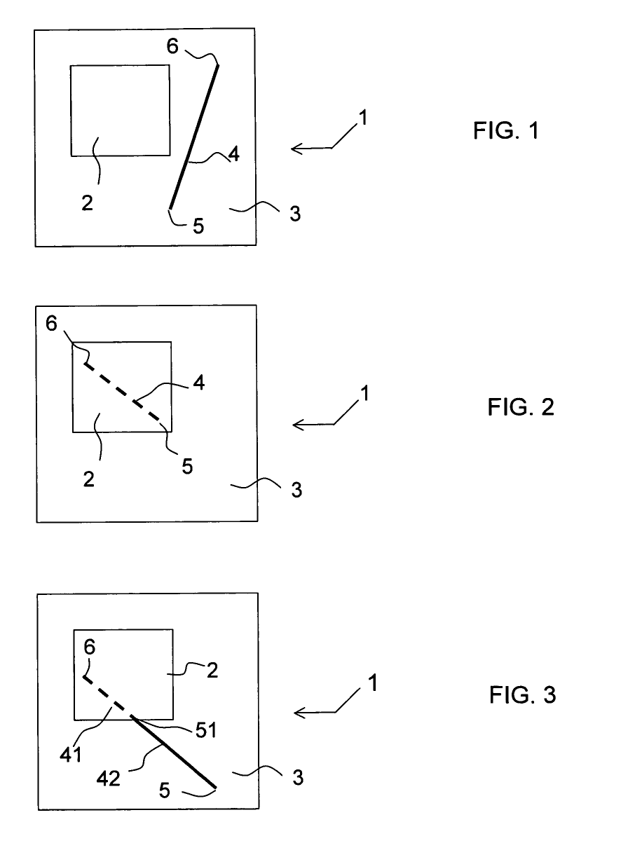

FIG. 1 shows a matrix display comprising one restricted area and one line situated outside of the restricted area;

FIG. 2 shows a matrix display comprising one restricted area and one line situated within the restricted area;

FIG. 3 shows a matrix display comprising one restricted area and one line situated partially within the restricted area;

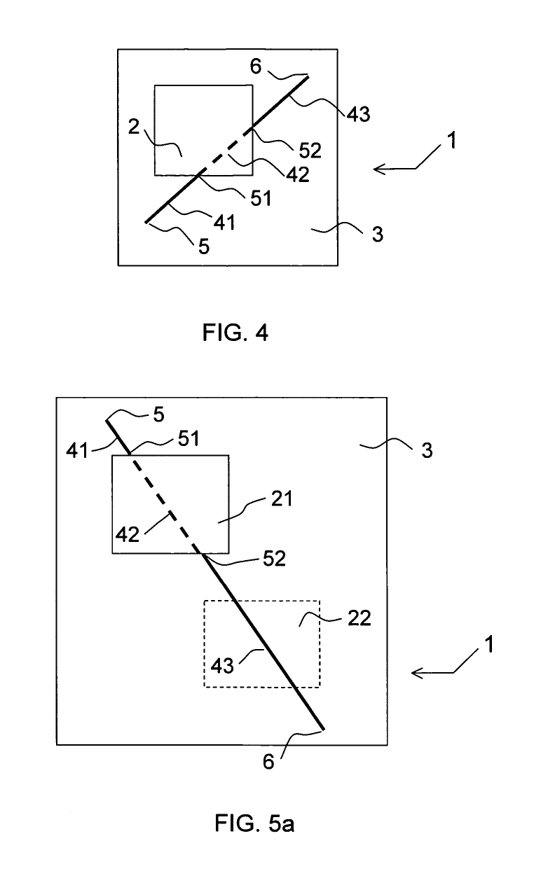

FIG. 4 shows a matrix display comprising one restricted area and one line running across the restricted area;

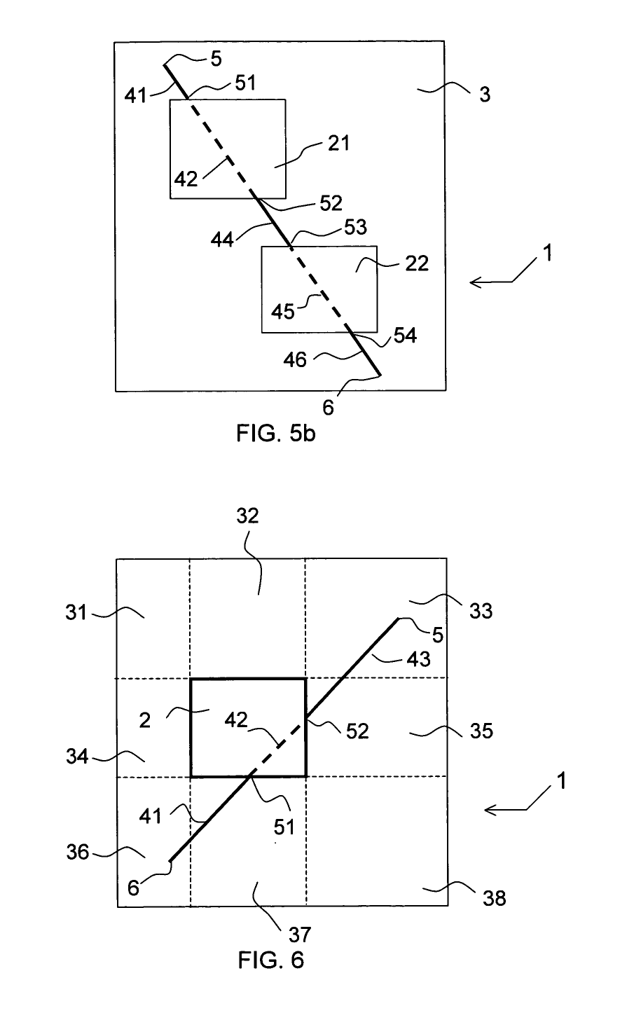

FIGS. 5a and 5b show a matrix display comprising two restricted areas and one line running across both restricted areas;

FIG. 6 shows the principle of the algorithm allowing the points of intersection between a line and a rectangular restricted area to be calculated.

The subject of the invention is a graphical generation method comprising a first step for calculating the segments of the line situated strictly within the allowed area and a second step for tracing said segments in the allowed area.

FIGS. 1, 2, 3 and 4 illustrate this method in the case where there exists only one restricted area 2 symbolized by a rectangle on the display 1 and in the various possible configurations of lines 4.

In FIG. 1, the line 4 is completely outside of the restricted area 2. It has no point of intersection with the restricted area 2. After the first calculation step, the line is retained in its entirety, which is symbolized by a solid line. All the points of the line are traced.

In FIG. 2, the line 4 is completely within the restricted area 2. It has no point of intersection with the restricted area 2. After the first calculation step, the line is entirely eliminated, which is symbolized by a dashed line. No points of the line are traced.

In FIG. 3, one of the ends 6 of the line is within the restricted area and the other end 5 is within the allowed area 3. In this case, the line has a point of intersection 51 with the restricted area. The segment 41, which is within the restricted area 2 and whose ends are the points 6 and 51, is eliminated, symbolized by a dashed line. The segment 42, which is within the allowed area 3 and whose ends are the points 5 and 51, is retained, symbolized by a solid line. All the points of this segment are traced.

In FIG. 4, the two ends of the line are within the allowed area but the line cuts the restricted area at the points 51 and 52. The segment 42, which is within the restricted area 2 and whose ends are the points 51 and 52, is eliminated, symbolized by a dashed line. The segments 41 and 43, which are within the allowed area 3 and whose ends are, respectively, the points 5 and 51 and 52 and 6 are retained, symbolized by solid lines. All the points of these segments are traced.

When the display comprises two separate restricted areas, the method comprises the following sub-steps:
Calculation of the points of intersection between the line and the first restricted area;
Calculation of the first segments of the line situated outside of the first restricted area;
Calculation of the points of intersection between each of the first segments and the second restricted area when there exists at least one first segment outside of the first restricted area;
Calculation of the second segments of the line situated outside of the first restricted area and outside of the second restricted area;
Tracing of said second segments within the allowed area, when there exists at least one second segment outside of the first restricted area and outside of the second restricted area.

FIGS. 5a and 5b illustrate the main steps of the method in the case of two separate restricted areas 21 and 22 disposed on a display 1. A line 4 crosses the two restricted areas 21 and 22.

FIG. 5a shows the first two sub-steps of the method. In this figure, as a reminder, the second area 22 appears as dashes. In FIG. 5a, the two ends 5 and 6 of the line are within the allowed area but the line cuts the restricted area at the points 51 and 52. The segment 42, which is within the restricted area 21 and whose ends are the points 51 and 52, is eliminated, symbolized by a dashed line. The segments 41 and 43, which are within the allowed area 3 and whose ends are, respectively, the points 5 and 51 and 52 and 6 are retained, symbolized by solid lines.

FIG. 5b shows the last two sub-steps of the method. The first segment 41, which is outside of the restricted area 22, is retained in its entirety. The two ends 52 and 6 of the segment 43 are within the allowed area but this segment cuts the restricted area 22 at the points 53 and 54. The segment 45, which is within the restricted area 22 and whose ends are the points 53 and 54, is eliminated, symbolized by a dashed line. The segments 44 and 46, which are within the allowed area 3 and whose ends are, respectively, the points 52 and 53 and 54 and 6 are retained, symbolized by solid lines. Finally, the segments 41, 44 and 46 are traced as indicated in FIG. 5b.

It goes without saying that this method can be generalized to a plurality of restricted areas. Accordingly, the line segments situated outside of the areas already examined are examined area by area.

In the vast majority of cases, the allowed areas or the restricted areas are rectangular windows into which video images are inserted. Various types of algorithms exist for calculating the points of intersection. By way of example, the Cohen-Sutherland algorithm can be used (Computer Graphics: Principles and Practice—Second Edition—Foley, vanDam, Feiner and Hugues—§ 3.1.2). The main steps of this algorithm are the following:
Step 1: Division of the display area into 8 allowed areas surrounding the rectangular restricted area 2 as indicated in FIG. 6. These areas are bounded by 4 lines situated along the extensions of the sides of the rectangle bounding the restricted area 2. Eight areas, numbered from 31 to 38 in FIG. 6, are thus obtained;
Step 2: Determination of the area to which the ends 5 and 6 of a line belong, by comparing the coordinates of the ends of the lines with those of the areas;
Step 3: Depending on the result of Step 2, there are 3 possible cases:
   The line belongs to the restricted area and it is eliminated;
   The line is entirely outside of the line and it is retained in its entirety;
   The line partially crosses the restricted area and the next step is performed;
Step 4: Calculation of a first point of intersection between the line and one side of the rectangle crossed by the line;
Step 5: For each segment bounded by one end of the line and the point of intersection, taking said segment as equivalent to a line, step 3 is repeated until all the segments obtained belong to either the restricted area, or to the allowed area.

1-6. (canceled)

7. A method for graphical generation of at least one straight line on a matrix display connected to a frame-buffer, the display having a restricted area and one allowed area complementary to the restricted area, that said method comprising the steps of:
calculating the segments of the line situated strictly within the allowed area; and
a tracing the segments in the allowed area, the frame-buffer being filled only once per generated graphics image.

8. The method for graphical generation as claimed in claim 7, comprising the following sub-steps, when the display comprises two separate restricted areas:
calculation of the points of intersection between the line and the first restricted area;
calculation of the first segments of the line situated outside of the first restricted area;
calculation of the points of intersection between each of the first segments and the second restricted area when there exists at least one first segment outside of the first restricted area;
calculation of the second segments of the line situated outside of the first restricted area and outside of the second restricted area;
tracing of said second segments in the allowed area, when there exists at least one second segment outside of the first restricted area and outside of the second restricted area.

9. The method for graphical generation as claimed in claim 8, wherein the ends of each segment are either an end of the line, or a point of intersection of the line with one of the restricted areas.

10. The method for graphical generation as claimed in claim 7, wherein the restricted areas are rectangular areas.

11. The method for graphical generation as claimed in claim 7, wherein the allowed areas are rectangular areas.

12. The method for graphical generation as claimed in claim 7, wherein the algorithm allowing the points of intersection to be calculated is of the Cohen-Sutherland or Cyrus-Beck type.
